(19) United States
(12) Patent Application Publication
(10) Pub. No.: US 2007/0094659 A1
(43) Pub. Date: Apr. 26, 2007

(54) System and method for recovering from a failure of a virtual machine

(75) Inventors: Sumankumar A. Singh, Pflugerville, TX (US); Peyman Najafirad, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/183,697

(22) Filed: Jul. 18, 2005

(51) Int. Cl. G06F 9/455

(52) U.S. Cl. 718/1

(57) ABSTRACT

A system and method is disclosed for the management of virtual machines in the nodes of a cluster network. An active virtual machine and a standby virtual machine are provided. In operation, a delta file is periodically created in the active node. The delta files include an indication of the changes between the virtual machine as measured at the present and at a preceding point in time. The delta files are transmitted to a standby virtual machine, where the files are applied to the standby virtual machine to synchronize the content of the active virtual machine and the standby virtual machine.

### TECHNICAL FIELD

The present disclosure relates generally to computer networks, and, more specifically, to a system and method for managing virtual machines in a computer network.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

Computer systems, including servers and workstations, are often grouped in clusters to perform specific tasks. A server cluster is a group of independent servers that is managed as a single system and is characterized by high availability, manageability, and scalability, as compared with groupings of unmanaged servers. At a minimum, a server cluster includes two servers, which are sometimes referred to as nodes.

In server clusters designed for high availability applications, each node of the server cluster is associated with a standby node. When the primary node fails, the application or applications of the node are restarted on the standby node. Each of the primary node and the standby node may include one or more virtual machines. Each virtual machine typically includes an application, operating system, and all necessary drivers. The virtual machines run on virtualization software that executes on the host operating system of the node. In operation, each virtual machine resembles an encapsulated file. A single node may include multiple virtual machines, and each virtual machine could be dedicated to the handling of a single task. As an example, one virtual machine on a node could be mail server, while another virtual machine present on the same physical server could be a file server. With respect to virtual machines, the virtual machines may be organized such that one virtual machine is an active virtual machine and a second virtual machine is the standby virtual machine. The active virtual machine may reside on the same physical node, or the active virtual machine and the standby virtual machine may reside on separate physical nodes.

When a node of the cluster fails, the applications of the failed node must be restarted on the surviving or standby node. Often, the reinstantiation of applications of the failed node on the standby node requires that the restarted applications be provided access to resources that were present on the failed node. Often the process of restarting, or failing over, an application from a failed node to a standby node results in the loss of current state of the application. As an example, some or all of the current transactions of the application may be lost during the failover process. In the case of a failed node that includes one or more virtual machines, the current state of one or more of the virtual machines could be lost during the failover process.

### SUMMARY

In accordance with the present disclosure, a system and method is disclosed for the management of virtual machines in the nodes of a cluster network. An active virtual machine and a standby virtual machine are provided. In operation, a delta file is periodically created in the active node. The delta files include an indication of the changes between the virtual machine as measured at the present and at a preceding point in time. The delta files are transmitted to a standby virtual machine, where the files are applied to the standby virtual machine to synchronize the content of the active virtual machine and the standby virtual machine. The active virtual machine may reside in an active node, and the standby virtual machine may reside in the standby node. In the event of a failure in the active node, the standby virtual machine of the standby node is converted to an active virtual machine.

The system and method disclosed herein is technically advantageous because it enhances failover performances and minimizes downtime in the operation of virtual machines in high availability cluster server environments. Because an identical or near identical copy of the virtual machine of the active node also exists in the standby node, the standby node can serve as a failover node in the event of a failure to the active node. In the event of such a failure, downtime is minimized or eliminated entirely, as both nodes include an identical or a near identical copy of the entire virtual machine. In the event of a failure, the standby node can be used very quickly, as applications of the virtual machine do not need to be restarted in the standby node, and resources do not need to be reallocated in the standby node. In addition, IP addresses used by the virtual machine do not need to be rebounded, and clients of the virtual machine do not have reissue requests to the virtual machine.

Another technical advantage of the system and method disclosed herein is the system and method disclosed herein is transparent to clients or users of the server nodes, including clients or users of the virtual machines of the server nodes. In operation, the user or client is not aware that incremental changes to a virtual machine are being logged and applied to a virtual machine in a standby node. Because an identical or near identical version of the virtual machine is present on the standby node, the user may also not be aware that a failure has occurred in the active node. Because a virtual machine of a failed node can be restarted quickly at a virtual node, and with the same content as existed in failed node, the user may not be aware that a failure has occurred in the failed node. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a server cluster network;

FIG. 2 is a flow diagram of a series of method steps for creating a delta file at the active node and transmitting that delta file to the standby node; and

FIG. 3 is a flow diagram of a series of method steps for receiving a delta file at a standby node and applying the delta file to a standby virtual machine at the standby node.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components. An information handling system may comprise one or more nodes of a cluster network.

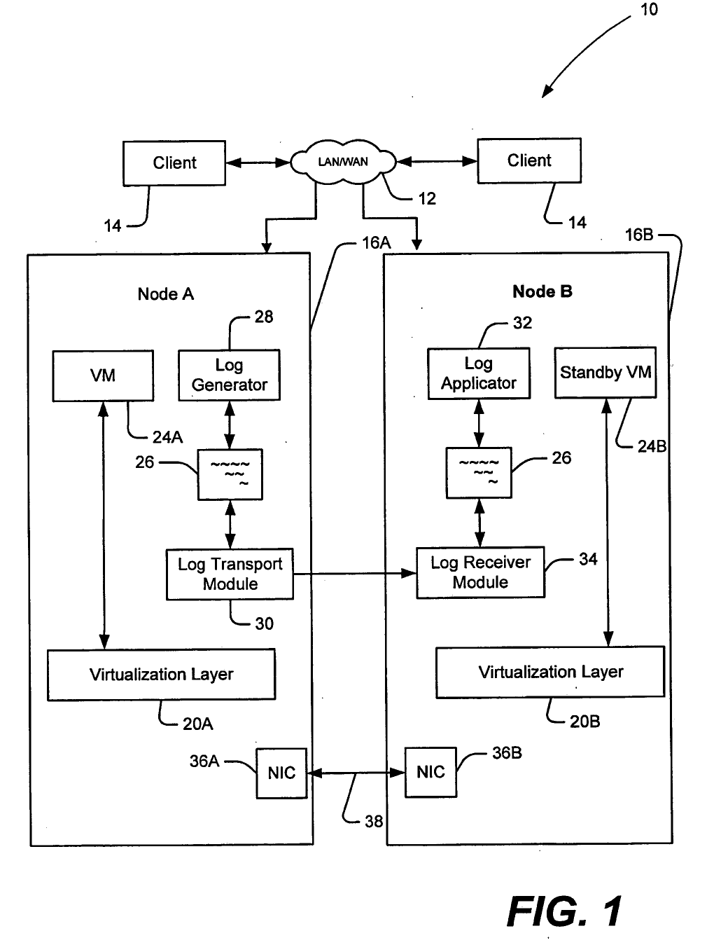

The system and method disclosed herein provides a method for managing the virtual machines of a node in preparation for a potential failure of the node. A standby virtual machine is maintained on the standby node. As incremental changes are made to the virtual machine of the active node, those incremental changes are logged and periodically applied to the standby node. In the event of a failure of the active node, the current state or the near current state of the virtual machine is present on the standby node. Shown in FIG. 1 is a diagram of a server cluster network, which is indicated generally at 10. Server cluster network 10 includes a LAN or WAN node 12 that is coupled to client nodes 14. LAN/WAN node 12 is coupled in this example to two server nodes, which are identified as Server Node A and Server Node B.

The servers of FIG. 1 may perform any server function and may comprise, for example, data servers, application servers, or web servers. Each of the server nodes will be referred to herein as physical nodes or servers to contrast these nodes with the virtual machines running on each of the servers. The elements of each server are identified with an alphabetical prefix that corresponds with an alphabetical indicator associated with the server node. Each server node 16 includes a virtualization layer 20, which separates the hardware and software of the physical server from the files of the virtual machine. Virtualization layer 20 includes the hardware of the server, the operating system of the server, and the virtual system software that runs on the operating system of the server and supports each virtual machine of the server. As indicated in each of the servers 16, a virtual machine 24a is supported by and communicates with the virtualization layer.

Each of the server nodes includes a virtual machine 24. Virtual machine includes application software an emulated version of a computer system, including an emulated version of the hardware and operating system of a computer system. From the perspective of a user of the server node, the presence of a virtual machine permits a user to execute the application within an emulated computing environment. From the perspective of the virtualization layer or the physical server node, the virtual machine resembles a single file or data structure. In operation active virtual machine 24A and standby virtual machine 24B identical. Virtual machine 24B can by creating a clone of virtual machine 24B. The process of creating clones of virtual machines is described in U.S. application Ser. No. 10/984,397, which is titled “System and Method for Hot Cloning in a Distributed Network,” which is incorporated herein by reference in its entirety. At the time that the clone is made of the active virtual machine, the active virtual machine and the standby virtual machine are in sync, as the content of each is identical.

Log generator 28 is a software utility that takes incremental snapshots of the differential content of the data structure or file comprising the active virtual machine 24A. A differential snapshot is a log file that identifies the difference between the virtual machine at a first point in time and the virtual machine at an immediately preceding point in time. A representation of a log file is shown at 26. The differential snapshot is defined as the difference in the file image of the active virtual machine at time t+x and the file image of the active virtual machine at time t. The differential snapshot is sometimes referred to as a delta file because the file represents the difference between the active virtual machine at two points in time. Log generator 28 may produce differential snapshots of the active virtual machine at regular timed intervals. Log generator 28 could also be configured to generate a differential snapshot of the active virtual machine each time that the active virtual machine is modified. The creation of log files is accomplished such that each modification to the active virtual machine is recorded in a log file. The delta files are received on the active node by a log transport module 30. The log transport module collects the delta files and periodically transmits the files to the standby node. The transmission of the delta files between the active node and the standby node can occur through a communication link between the two nodes. One example of a suitable communications link is communications link 38 between the network interface cards 36 of each node.

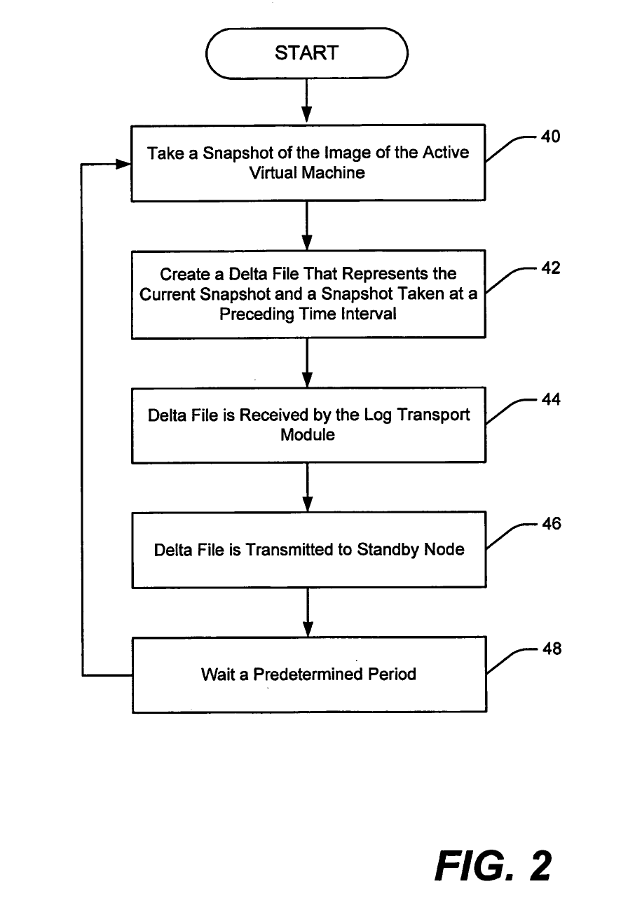

In standby node B, the delta files are received at log receiver module 34. Log receiver module 34 transmits the log files 26 to a log applicator module 32. The function of the log applicator module 32 is to periodically apply the log files to the content of the standby virtual machine 24B so that the content or file image of the standby virtual machine is a duplicate or near duplicate of the content or file image of the active virtual machine. The process of creating a log file of the active virtual machine at the active node, transmitting the log file to the standby node, and updating the content of the standby virtual machine at the standby node is repeated every few seconds to ensure that the content of the active virtual machine and the standby virtual machine are the same or nearly the same. Shown in FIG. 2 is a flow diagram of a series of method steps for creating a delta file at the active node and transmitting that delta file to the standby node. At step 40, a snapshot is taken of the file that constitutes the active virtual machine. At step 42, a delta file is created that represents the difference in the content between current snapshot and a snapshot taken at the preceding time interval. Thus, the delta file represents the difference between the virtual machine at time t and a time t+x. At step 44, the delta file is archived or received by the log transport module, and, at step 46, the delta file is transported to the standby node. At step 48, the flow diagram pauses and begins to repeat at step 40. It should be recognized that, as an alternative to repeating the steps of FIG. 2 periodically, the steps of FIG. 2 could be performed each time there is a change to the image of the active virtual machine.

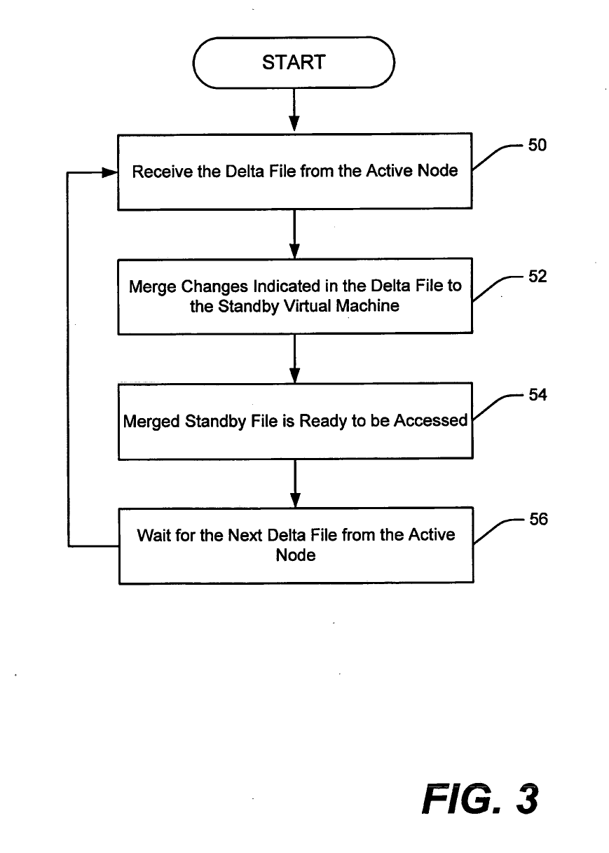

Shown in FIG. 3 is a flow diagram of a series of method steps for receiving a delta file at a standby node and applying the delta file to a standby virtual machine at the standby node. At step 50, the delta file is received at the standby node from the active node. The delta file is received at the log receiver module of the standby node. At step 52, the log applicator module merges the changes represented by the delta file with the existing standby virtual machine. At step 54, the newly merged standby virtual machine is complete and available to be accessed by a client in the event of a failure of the standby node. At step 56, the flow diagram halts until the next delta file is transmitted from the active node.

The status of the active node is monitored by a failover or heartbeat utility that operates on each of the nodes and communicates through a communications link between the two nodes. As one example, the failover or heartbeat utility may communicate between the nodes through the communications link 38, which is coupled between the network interface cards 36 of each node. If the failover utility determines that the active node has failed and is not responding to the failover utility, the standby virtual machine 24B replaces the active virtual machine 24A of the active node and receives all requests and communications from the clients of the failed active node 24A. From the perspective of the user, the transition from the active virtual node to the standby virtual node is seamless and transparent. The client is not aware that a transition has occurred, and the client, in most instances, is not required to reissue any requests to the standby virtual node.

Because the failover process described herein involves the instantaneous and seamless transition between virtual machines, the system and method described herein may be used in the case of high availability virtual machines. In addition, the system and method described herein may be used with virtual machines that are not cluster aware. The virtual machines need not be aware that differential files are being created for the purpose of creating and maintaining an identical standby virtual machine in a standby node. The system and method disclosed herein may also be used in disaster recovery applications in which it is desirable to have a standby version of an active virtual machine. It is expected that, in some situations, an additional software license may not be needed for the standby virtual machine. Until the standby virtual machine is activated, a license may not be necessary for the standby virtual machine.

The system and method disclosed herein is not limited in its application to the computer network architecture disclosed herein. The system and method described herein may be used in computer networks having multiple servers and in computer networks in which one or more of the servers includes multiple virtual machines. It should also be recognized that the system and method disclosed herein may be employed in an environment in which the active virtual machine and the standby virtual machine are employed on the same physical node. The failover and synchronization steps of the present disclosure can be implemented in an architecture in which the virtual machines are implemented on a single physical node. Although the present disclosure has been described in detail, it should be understood that various changes, substitutions, and alterations can be made hereto without departing from the spirit and the scope of the invention as defined by the appended claims.

What is claimed is:

1. A method for managing the operation of virtual machines in a computer network, comprising:
establishing an active virtual machine on a first node;
establishing a standby virtual machine on a second node;
creating a differential file in the first node, wherein the differential file represents the differences between the image of the active virtual machine at a first point in time and the image of the active virtual machine at a second point in time; and
applying each differential file to the standby virtual machine on the standby node.

2. The method for managing the operation of virtual machines in a computer network of claim 1, wherein a differential file is created in the first node at a regular interval.

3. The method for managing the operation of virtual machines in a computer network of claim 1, wherein a differential file is created in the first node each time that the image of the active virtual machine is modified.

4. The method for managing the operation of virtual machines in a computer network of claim 1, further comprising:
recognizing a failure in the first node; and
converting the standby virtual machine of the second node to an active virtual machine.

5. The method for managing the operation of virtual machines in a computer network of claim 4, wherein the step of recognizing a failure in the first node comprises the step of recognizing the failure of the first node through a heartbeat utility maintained on each of the first node and the second node.

6. The method for managing the operation of virtual machines in a computer network of claim 1, wherein a differential file is created in the first node at a regular interval, and further comprising:
recognizing a failure in the first node comprises the step of recognizing the failure of the first node through a heartbeat utility maintained on each of the first node and the second node; and
converting the standby virtual machine of the second node to an active virtual machine.

7. The method for managing the operation of virtual machines in a computer network of claim 1, wherein a differential file is created in the first node each time that the image of the active virtual machine is modified, and further comprising:
recognizing a failure in the first node comprises the step of recognizing the failure of the first node through a heartbeat utility maintained on each of the first node and the second node; and
converting the standby virtual machine of the second node to an active virtual machine.

8. A computer network, comprising:
a first node, wherein the first node includes an active virtual machine and a utility for the creation of multiple delta files, wherein each delta file represents the differences between the image of the active virtual machine at a first point in time and the image of the active virtual machine at a second point in time;
a second node, wherein the second node include a standby virtual machine and a utility for receiving delta files from the first node and applying those delta files to the standby virtual machine such that the content of the standby virtual machine is updated to reflect the content of the active virtual machine at the time of the creation of the applied delta file; and
a communications link between the first node and the second node.

9. The computer network of claim 8, wherein the utility of the first node is operable to create delta files at predetermined intervals.

10. The computer network of claim 8, wherein the utility of the first node is operable to create a delta file following each modification to the active virtual machine.

11. The computer network of claim 8, further comprising a failover utility operating on each of the first node and the second node, wherein the failover utility is operable to recognize a failure of the first node and convert the standby virtual machine of the second node to an active virtual machine.

12. The computer network of claim 8, further comprising a failover utility operating on each of the first node and the second node, wherein the failover utility is operable to transmit periodic communications between over the communications link between the first node and the second node to recognize a failure of the first node and convert the standby virtual machine of the second node to an active virtual machine.

13. The computer network of claim 8, wherein the utility of the first node is operable to create delta files at predetermined intervals, and further comprising a failover utility operating on each of the first node and the second node, wherein the failover utility is operable to transmit periodic communications between over the communications link between the first node and the second node to recognize a failure of the first node and convert the standby virtual machine of the second node to an active virtual machine.

14. The computer network of claim 8, wherein the utility of the first node is operable to create a delta file following each modification to the active virtual machine, and further comprising a failover utility operating on each of the first node and the second node, wherein the failover utility is operable to transmit periodic communications between over the communications link between the first node and the second node to recognize a failure of the first node and convert the standby virtual machine of the second node to an active virtual machine.

15. A method for managing the operation of virtual machines in a computer network, comprising the steps of:
monitoring the operation of an active virtual machine in an active node;
identifying modifications to the image of the active virtual machine;
on the basis of the identified modifications to the image of the active virtual machine, updating the image of a standby virtual machine in a standby node to reflect the image of the standby virtual machine.

16. The method for managing the operation of virtual machines in a computer network of claim 15, wherein the step of identifying modifications to the image of the active virtual machine comprises the step of creating a differential file that represents the differences between the image of the active virtual machine at a first point in time and the image of the active virtual machine at a second point in time.

17. The method for managing the operation of virtual machines in a computer network of claim 15, further comprising the step of identifying a failure of the first node and converting the standby virtual machine to an active virtual machine.

18. The method for managing the operation of virtual machines in a computer network of claim 16, wherein the differential file is created at predetermined intervals.

19. The method for managing the operation of virtual machines in a computer network of claim 16, wherein the differential file is created in response to a modification to the active virtual machine.

20. The method for managing the operation of virtual machines in a computer network of claim 15,
wherein the step of identifying modifications to the image of the active virtual machine comprises the step of creating a differential file that represents the differences between the image of the active virtual machine at a first point in time and the image of the active virtual machine at a second point in time; and
further comprising the step of identifying a failure of the first node and converting the standby virtual machine to an active virtual machine.
